(19) United States
(12) Patent Application Publication
(10) Pub. No.: US 2007/0215671 A1
(43) Pub. Date: Sep. 20, 2007

(54) Manufacturing Plant in Particular a Rotational Friction Welding Plant with at Least One Adjuster Device Comprising Two Interleaved Frames

(75) Inventors: Ulrich Knott, Muenchen (DE); Erwin Bayer, Dachau (DE); Martin Bussmann, Schwabhausen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MTU AERO ENGINES GMBH, MUENCHEN (DE)

(21) Appl. No.: 10/594,607

(22) PCT Filed: Mar. 11, 2005
(86) PCT No.: PCT/DE05/00436

§ 371 Date: Sep. 28, 2006

(30) Foreign Application Priority Data
Mar. 29, 2004 (DE) 10 2004 015 299.3

(51) Int. Cl. B23K 20/12

(52) U.S. Cl. 228/2.3

(57) ABSTRACT

A manufacturing plant, in particular, a rotational friction welding plant for the joining of two components, with two part systems for mutual alignment is disclosed. According to the invention, at least one of both part systems for mutual alignment is provided with an adjustment device, comprising two interleaved frames, whereby two groups, each with at least three adjustment devices, are arranged between the two frames of the adjustment device at an axial separation from each other.

The present invention relates to a manufacturing system, in particular a rotary friction welding machine, according to the definition of the species in Patent claim 1.

Friction welding is a widely used joining method in the manufacturing of gas turbines. Friction welding is part of what is known as pressure welding methods, a distinction being made in friction welding between linear friction welding and rotary friction welding or friction-stir welding. In rotary friction welding, rotationally symmetric components are joined or bonded together via friction. In rotary friction welding, a first component rotates while the other component is stationary and is pressed against the rotating component using a certain force. In the process, the joining surfaces of the components to be joined together are fitted to one another via hot forging.

Rotary friction welding is carried out on rotary friction welding machines, the rotating component being supported on a rotating spindle and the stationary component being supported on a non-rotating spindle according to the related art. In rotary friction welding, it is of particular importance to exactly position, i.e., align the two components to be joined together to one another. According to the related art, the stationary side and rotating side of a rotary friction welding machine are aligned using wedges. Alignment with the aid of wedges can only be carried out with great difficulty and does not permit a dynamic or controlled alignment of the components to be welded together during the welding process. In rotary friction welding machines known from the related art, adjustment of the components to be welded together is thus only possible on a limited basis. Furthermore, alignment with the aid of wedges does not take into account either a deflection of the rotary friction welding machine due to changing inertial mass members or the thermal warping under changing environmental conditions, thereby limiting the achievable accuracy of the rotary friction welded joint. Incidentally, similar problems can be detected in all manufacturing systems which have two subsystems to be aligned with one another.

On this basis, the object of the present invention is to create a novel manufacturing system, in particular a novel rotary friction welding machine.

This object is achieved in that the initially mentioned manufacturing system, in particular the rotary friction welding machine, is refined by the features of the characterizing part of Patent claim 1. According to the present invention, an adjusting device having two interleaved frames is assigned to at least one of the two subsystems to be aligned with one another, two groups, each having at least three actuators, being situated between the two frames of the adjusting device, axially distanced from one another.

A dynamic or controlled alignment of the two subsystems of the manufacturing system is possible during the manufacturing process using the manufacturing system according to the present invention. In the case of rotary friction welding, it means that the alignment of the rotating spindle with the non-rotating spindle may be dynamically influenced during the rotary friction welding process, thereby simplifying the configuration of the manufacturing system. Moreover, it is possible to enhance the manufacturing quality.

According to an advantageous refinement of the present invention, the relative position of the subsystems to be aligned with one another is continuously measurable, dynamic alignment of the two subsystems to be aligned with one another taking place during operation of the manufacturing system as a function of a measurement via the or each adjusting device.

Preferred refinements of the present invention arise from the subclaims and the following description. Exemplary embodiments, without being restricted thereto, are explained in greater detail on the basis of the drawing.

FIG. 1 shows a schematic representation of a manufacturing system which is designed as a rotary friction welding machine;

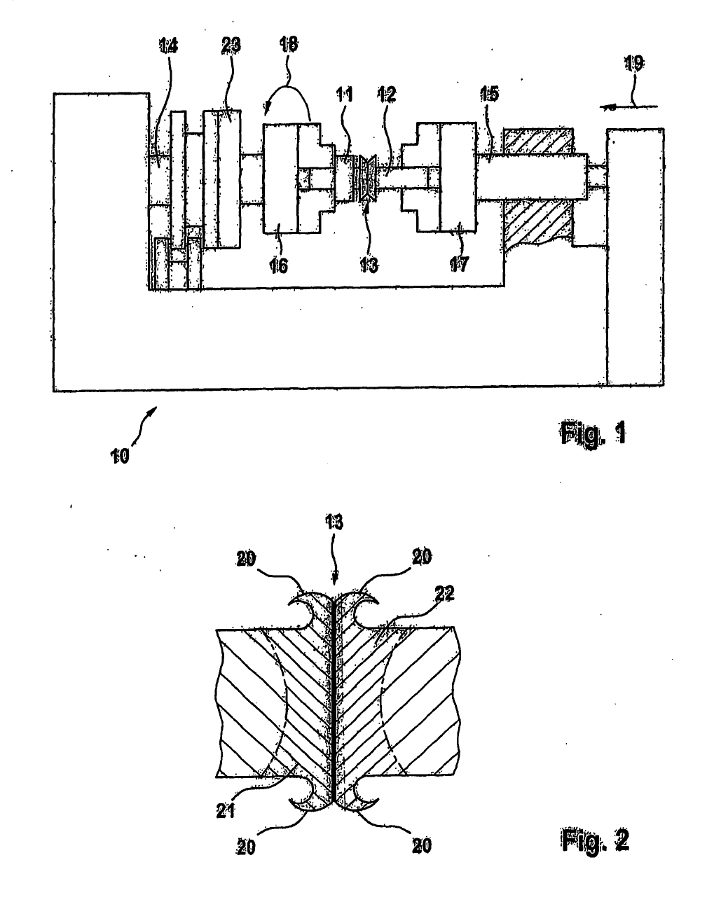

FIG. 2 shows a joint seam between two components joined together;

FIG. 3 shows a schematic detail of a manufacturing system according to the present invention, designed as a rotary friction welding machine, in a first exemplary embodiment of the present invention in a front view;

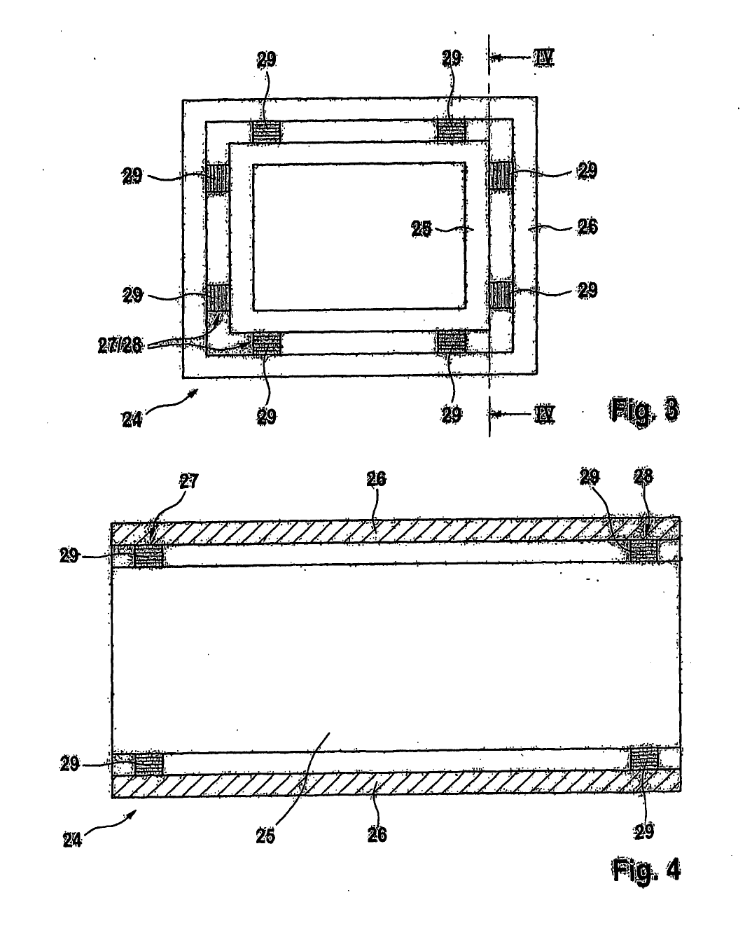

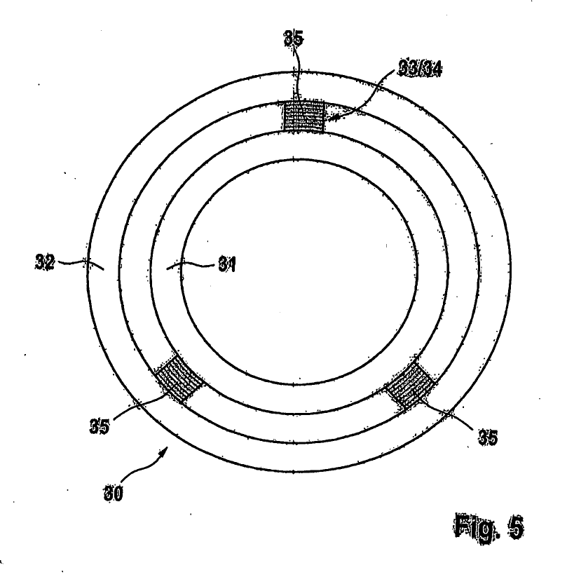

FIG. 4 shows a cross section of the detail in FIG. 3 along the cut direction IV-IV, and

FIG. 5 shows a schematic detail of a manufacturing system according to the present invention, designed as a rotary friction welding machine, in a second exemplary embodiment of the present invention in a front view.

FIG. 1 shows the schematic configuration of a manufacturing system designed as a rotary friction welding machine 10 for joining two components 11 and 12, a joint seam 13, shown on a larger scale in FIG. 2, being formed between components 11 and 12 during rotary friction welding.

Rotary friction welding machine 10, shown in FIG. 1, has two subsystems to be aligned with one another, namely via first spindle 14 and a second spindle 15. Component 11 of components 11 and 12 to be joined together is situated and supported on first spindle 14 and component 12 is situated and supported on second spindle. For this, clamping devices 16 and 17 are assigned to spindles 14 and 15. Using these clamping devices 16 and 17, components 11 and 12 to be joined together are mountable on respective spindles 14 and 15. First spindle 14 is assigned at least one inertial mass member 23.

In order to join both components 11 and 12 with the aid of rotary friction welding, component 11, supported on first spindle 14, is rotated in the direction of arrow 18, while component 12, supported on second spindle 15, is pressed against component 11 in the direction of arrow 19 using a force. The relative rotation between components 11 and 12 and this force generate friction and thus heating of both components 11 and 12 on contact surfaces or joint surfaces 21, 22 of same. Hot forging of the material of components 11 and 12 takes place on contact surfaces or joint surfaces 21, 22. Joint seam 20, shown schematically in FIG. 2, is formed in the process.

It is of importance when joining both components 11 and 12 that, after joining, the longitudinal axes or longitudinal center axes of both components 11 and 12 are on top of one another or coincide and that no misalignment exists between the longitudinal axes. For this it is necessary to exactly align both spindles 14, 15 with one another.

According to the present invention, an adjusting device 24 is assigned to at least one of the two spindles 14 and 15. FIGS. 3 and 4 show a first exemplary embodiment of such an adjusting device.

The adjusting device includes two interleaved frames 25 and 26. Interleaved frames 25 and 26 in the exemplary embodiment of FIGS. 3 and 4 are designed as concentric tubes which have a rectangular cross section. To this end, adjusting device 24 includes an inner tube 25 and an outer tube 26, outer tube 26 enclosing inner tube 25.

Two groups 27 and 28 of multiple actuators 29 are situated at an axial distance between the two interleaved frames 25 and 26, i.e., between the two tubes. In the exemplary embodiment in FIGS. 3 and 4, each group 27 and 28 includes a total of eight actuators 29. In the exemplary embodiment in FIGS. 3 and 4, each of actuators 29 is preferably fixedly connected to one of the two frames 25 or 26, while actuators 29 are movable with respect to the other frame 26 or 25.

Actuators 29 are preferably designed as piezoelectric actuators. By selectively decreasing or increasing the cross-sectional dimensions of actuators 29, designed as piezoelectric actuators, both frames 25 and 26 of adjusting device 24 can be exactly aligned with one another. Due to the fact that two groups 27 and 28 of actuators 29 are positioned one behind another at an axial distance, it is not only possible to align both frames 25 and 26 horizontally and vertically, but also both frames 25 and 26 may be angled toward one another in such a way that the longitudinal center axes of both frames do not run parallel to another, but rather form an angle.

As mentioned above, such an adjusting device 24 may be assigned to each spindle 14 and 15 of rotary friction welding machine 10. In the case in which such an adjusting device 24 is assigned to both spindles 14 and 15, rotating spindle 14 and stationary spindle 15 are supported in inner frame 25 of adjusting device 24. It should be pointed out that such an adjusting device 24 may be assigned to only one spindle, i.e., either rotating spindle 14 or non-rotating spindle 15.

In contrast to the exemplary embodiment shown in FIGS. 3 and 4, it is possible, of course, to place only four actuators between inner frame 25 and outer frame 26 of adjusting device 24. The number of actuators 29 between inner ring 25 and outer ring 26, which have a rectangular cross-sectional design in the exemplary embodiment in FIGS. 3 and 4, must be at least four.

FIG. 5 shows another exemplary embodiment of an adjusting device 30 for a manufacturing system according to the present invention, in particular a rotary friction welding machine according to the present invention. Adjusting device 30 in FIG. 5 has again two interleaved frames 31 and 32, both interleaved frames in the exemplary embodiment in FIG. 5 being designed as concentric tubes having a ring-shaped cross section. As is apparent from FIG. 5, inner tube 31 is concentrically enclosed by outer tube 32. Here again, two groups 33 and 34 of actuators 25 are positioned at an axial distance between the two frames 31 and 32 designed as concentric tubes having a ring-shaped cross section. Actuators 35 are again designed as piezoelectric actuators, each group 33 and 34 having at least three actuators 35 in the exemplary embodiment shown in FIG. 5. Using adjusting device 30 of FIG. 5, it is also possible to adjust two axes with regard to angle and position. By selectively increasing or decreasing the cross-sectional profiles of actuators 35, designed as piezoelectric actuators, both frames 31 and 32 may be displaced in the horizontal and vertical direction with respect to one another. Moreover, both frames 31 and 32 may be angled relative to one another.

A rotary friction welding machine 10 having such adjusting devices 24 or 30 makes it possible to dynamically align components 11 and 12 to be joined together or the two spindles 14 and 15 during the rotary friction welding process. The rotary friction welding machine according to the present invention makes it possible to continuously detect the relative position of both components 11 and 12 to be joined together during rotary friction welding and to ultimately align both spindles 14 and 15 and thus both components 11 and 12 to be joined together in a dynamic or controlled manner by influencing actuators 29 or 35 of adjusting devices 24 or 30 as a function of corresponding measurements, whereby the quality of the rotary friction welded joint may be clearly improved.

As mentioned above, actuators 29 and 35 are preferably designed as piezoelectric actuators. Piezoelectric actuators allow for a highly accurate fine adjustment in the micrometer range, the piezoelectric actuators requiring only little installation space. In the preferred application of a rotary friction welding machine, using the present invention makes it possible to adjust the stationary and the rotatory sides or the stationary and the rotatory subsystem of the rotary friction welding machine accurately to the micrometer prior to and during rotary friction welding.

Although the present invention has been described using the example of a rotary friction welding machine with reference to FIGS. 1 through 5, the principle of alignment or adjustment according to the present invention is transferable to other manufacturing systems or manufacturing machines. The present invention is usable everywhere where two subsystems of a manufacturing system must be aligned with one another in a highly accurate manner. Both subsystems to be aligned may rotate or may be stationary. It is also possible that one of the two subsystems to be aligned with one another rotates while the other subsystem is stationary.

1-11. (canceled)

12. A rotary friction welding machine for joining a first component to a second component comprising: a first spindle and a second spindle, the first spindle and the second spindle forming the two subsystems to be aligned with one another, the first spindle supporting the first component and the second spindle supporting the second component and an adjusting device being assigned to align the first spindle and/or to align the second spindle, the adjusting device including two interleaved frames and two groups each group having at least three actuators and being positioned between the two frames at an axial distance from one another.

13. The rotary friction welding machine as recited in claim 12, wherein the two interleaved frames are designed as concentric tubes having a ring-shaped cross section, the two groups, each having the at least three actuators, being positioned between the two tubes at an axial distance from one another.

14. The rotary friction welding machine as recited in claim 12, wherein the two interleaved frames are designed as tubes having a rectangular cross section, two groups, each having at least four actuators, being positioned between the two tubes at an axial distance from one another.

15. The rotary friction welding machine as recited in claim 12, wherein the actuators are fixedly connected to at least one of the interleaved frames.

16. The rotary friction welding machine as recited in claim 15, wherein the actuators are fixedly connected to one of the interleaved frames and are movable with respect to the other frame.

17. The rotary friction welding machine as recited in claim 12, wherein the actuators are designed as piezoelectric actuators.

18. The rotary friction welding machine as recited in claim 12, wherein a relative position of the first spindle and the second spindle or of the first and second components to be joined together is measured continuously and that the first and second spindles and thus the two components to be joined together are dynamically aligned during operation of the rotary friction welding machine via the adjusting device as a function of the measurement.
